(19) United States
(12) Patent Application Publication
(10) Pub. No.: US 2004/0119205 A1
(43) Pub. Date: Jun. 24, 2004

(54) Rotating turret molding machine and associated process

(75) Inventors: Kenneth Eichhorn, Lexington, OH (US); Christopher Filos, Brick, NJ (US)

Correspondence Address: WOOD, HERRON & EVANS, LLP, 2700 CAREW TOWER, 441 VINE STREET, CINCINNATI, OH, 45202, US

(73) Assignee: Taylor's Industrial Services, LLC

(21) Appl. No.: 10/684,099

(22) Filed: Oct. 10, 2003

Related U.S. Application Data
(60) Provisional application No. 60/417,908, filed on Oct. 11, 2002.
(60) Provisional application No. 60/460,522, filed on Apr. 4, 2003.

(51) Int. Cl. B29B 7/00; B29C 45/00

(52) U.S. Cl. 264/328.8; 264/328.11; 425/574; 425/588

(57) ABSTRACT

A molding machine and associated process offers significantly reduced cycle time and increases production output. In one embodiment, an injection molding machine includes a rotatable turret block rotatable on an axis for rotating a plurality of movable platens thereof into alignment with a stationary platen. Each of the movable platens include at least one which can be mated with a die on the stationary platen for molding a molded article. The machine may include multiple, opposed stationary platens for alternately mating with the moveable platens. The rotatable turret significantly reduces cycle time and increases production output without an increase in required floor space.

This claims the benefit of U.S. Provisional Applications Serial No. 60/417,908 filed Oct. 11, 2002 and Serial No. 60/460,522 filed Apr. 4, 2003, each of which is hereby incorporated by reference in its entirety.

### BACKGROUND OF THE INVENTION

This invention is directed to a molding or casting machine, and more particularly, to a molding or casting machine having a rotating and longitudinally movable turret block with a plurality of mold halves rotatable and movable into engagement with at least one non-rotatable mold half, and the associated molding/casting process.

Injection molding machines having turret configurations for moving mold halves or platens into and out of alignment with other mold halves or platens are well known in the prior art. A turret type configuration for injection molding is beneficial since it lends itself to high volume production of molded parts. This is true since different molding related operations can be performed using the turret configuration, simultaneous to the actual molding of the part. That is, while one part is being molded on the turret block, another part having already been molded or to be molded can be subjected to a plurality of post molding or pre-molding operations. These operations include, for example, injecting, holding, cooling and ejecting, each of which can be performed at a different angular position relative to the actual molding operation. Some prior art machines have a turret with a vertical axis of rotation, while still others have a horizontal axis of rotation. With respect to the known prior art, no molding or casting machines have the objects and advantages discussed below and derived from the devices disclosed herein. That is, each of the known prior art devices has a relatively complex construction, and a greater number of moving parts. Accordingly, those prior art devices inefficiently use excess floor space, exhibit greater energy consumption, and have relatively long cycle times.

There exists a need, therefore, for a multiple platen casting/molding machine and associated method of operation which significantly reduces cycle time, is efficient in high volume production of parts and has a relatively simple and reliable construction to minimize capital costs and repairs.

### SUMMARY OF THE INVENTION

The primary object of this invention is to provide an energy and space efficient multi-platen molding/casting machine having a reduced cycle time which includes a longitudinally movable and rotatable turret block.

Another object of this invention is to provide such a multi-platen machine including a longitudinally movable and rotatable turret block, wherein combinations of pre-mold and/or post mold operations may be efficiently achieved on one machine while molding/casting operations are on-going, using different stations of the turret block, thereby reducing cycle time.

Yet another object of this invention is to provide such a machine using a movable and rotatable turret block which includes a plurality of mold halves movable toward and away from one or more mating stationary mold halves for forming molds for making a variety of parts in an energy and cycle time efficient manner.

These and other disclosed objects and advantages are achieved by the molding/casting machine and associated method of this invention. The machine in one embodiment includes a first mold half or die mounted on a stationary platen and a turret rotatable on an axis for positioning a number of movable mold halves or dies thereof into alignment with the stationary die. In one embodiment, this invention includes a machine having a turret with a number of movable platens, wherein the turret is rotatable on a horizontal axis and longitudinally movable for placement into and out of engagement with a stationary platen, thereby reducing floor space usage and energy consumption and increasing efficiency.

In another embodiment, the machine includes dual, opposing first mold halves, each mounted on a stationary platen with the rotatable turret mounted therebetween so that a mold half or die on the turret is alternatively mated with the mold halves on the stationary platens. This configuration significantly increases production and efficiency while minimizing the required floor space and capital expense.

### BRIEF DESCRIPTION OF THE DRAWINGS

The objectives and features of the invention will become more readily apparent from the following detailed description taken in conjunction with the accompanying drawings in which:

FIG. 1 is a perspective view of one embodiment of an injection molding machine according to this invention;

FIGS. 2-5 are sequential top elevational views of the machine of FIG. 1 during a representative molding operation;

FIG. 6 is perspective view of a second embodiment of an injection molding machine in an open position and in accordance with the principles of this invention;

FIG. 7 is a top plan view of the machine of FIG. 6 in an open position; and

FIG. 8 is a side elevational view of the machine of FIG. 6.

### DETAILED DESCRIPTION OF THE INVENTION

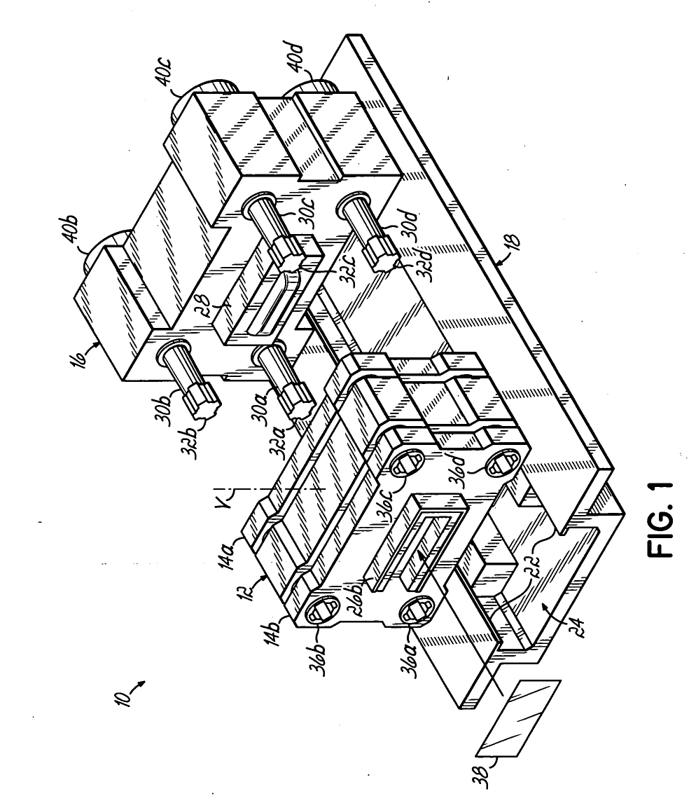

Referring now to the drawings in detail there is shown in FIG. 1 a perspective view of one embodiment of an injection molding machine of the present invention, which is designated generally as 10. Injection molding machine 10 generally includes a rotatable turret 12 with a plurality of movable mold halves or platens 14a, 14b, and a stationary mold half or platen 16 all positioned on base 18. The machine 10 includes an injection unit (not shown) for introducing injection material utilized in the production of parts 20a, 20b, or the like.

Injection molding machine 10 may be used for molding a variety of different types of parts or articles 20a, 20b and accordingly, is not limited for use with any particular type of article. In one application, the parts may be molded bumpers for cars, automobiles or the like. The bumpers may be manufactured in a wide variety of colors which are advantageously produced by a color pre-form or blank 38 positioned on the platens 14a, 14b prior to molding of the bumper 20a, 20b.

While the turret 12 is shown throughout this description as rotatable on a vertical axis V, and this is the preferred embodiment, it is feasible that a similar design of a movable turret 12 providing the advantages of this invention may be provided which is rotatable on a horizontal or other axis. Accordingly, this invention is not considered limited to the vertical axis feature.

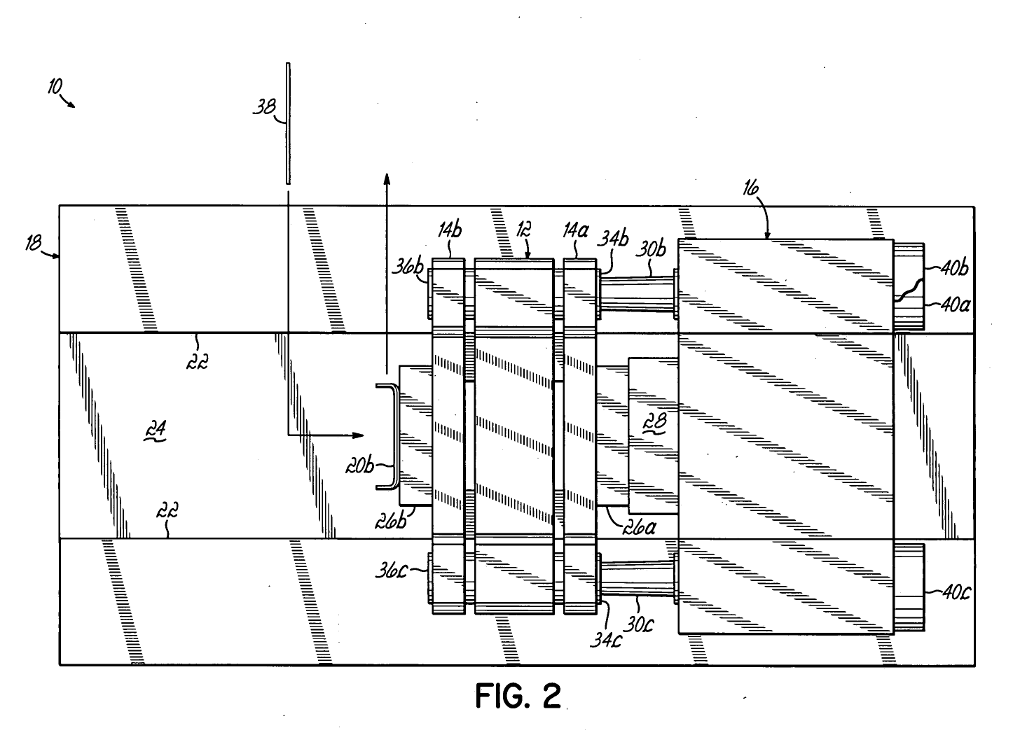

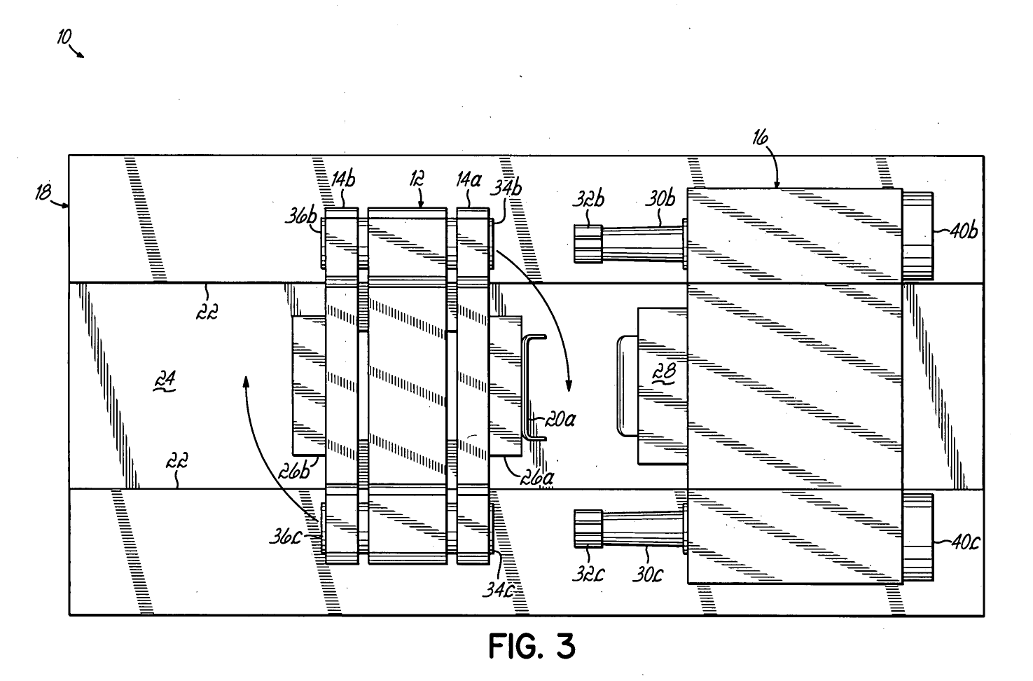

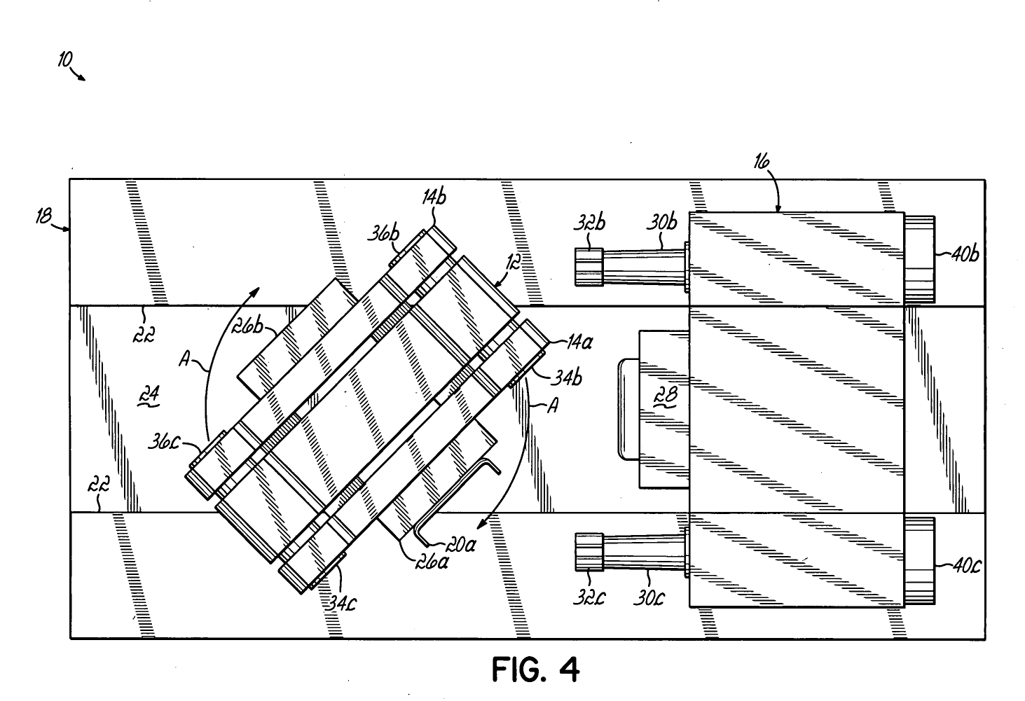

As shown in FIGS. 2-5, turret 12 is preferably longitudinally movable on base 18 via a set of rollers (not shown) attached to the bottom of the turret 12. Base 18 includes hardened rails 22 in a guideway 24 which engage rollers. Turret 12 is rotatable preferably by a motor (not shown) mounted therein and more preferably an electric servo drive motor. Preferably, the electric servo drive motor is connected via a belt drive about vertical axis V for rotating turret 12 (FIGS. 3-4). The electric servo drive motor is preferably mounted on the turret 12 proximate the base 18.

As shown in FIG. 1, turret 12 includes a number of movable platens 14a, 14b, i.e. movable mold halves, each of which includes a set of dies 26a, 26b, respectively, each set adapted for engagement with a die 28 located in stationary platen 16. Preferably, two movable mold halves or platens are provided on turret 12, although any number supportable by the size of the turret 12 can be used. Sets of dies 26a, 26b are adapted to be rotated into horizontal and vertical alignment with die 28.

Turret 12 is movable backward and forward along hardened rails 22 on base 18 via piston/cylinder assemblies (not shown) positioned in stationary mold half and platen 16. Tie bars 30a-30d extend from the stationary platen 16 and are connected at distal ends thereof to turret 12 when the machine 10 is closed. Locking bushings 32a-32d are on the distal ends of the tie-bars 30a-30d, respectively, for locking engagement in sets of locking collars 34a-34d and 36a-36d on platens 14a, 14b, respectively, of the turret 12. The tie-bar mechanism is preferably hydraulic and includes clamping cylinders 40a-40d on the stationary platen. One example of the hydraulic tie-bar clamping mechanism is shown in U.S. Patent Publication No. US 2003/0102102, published Jun. 5, 2003, assigned to the assignee of this invention and hereby incorporated by reference.

Services are provided continuously to turret 12. Accordingly, as turret 12 rotates, services are continuously supplied to the movable platens 14a, 14b. Such services include the supply of electricity, pressurized fluid, cooling fluids, and hydraulic fluids, etc. For using these services, turret 12 also includes the required circuitry and control valves (not shown) on board and movable and rotatable with the turret 12.

Injection unit (not shown), preferably in the form of a reciprocating screw injection unit, for injection molding applications of the machine 10 is connected with stationary platen 16 positioned on base 18 for providing melt to the dies for molding.

As discussed above, injection molding machine may include a plurality of platens 14a, 14b on the turret 12, although more or less platens may be used, positioned adjacent the periphery of turret 12, which platens are used for the performance of pre-molding or post-molding operations simultaneously with an on-going molding operation. As shown in FIGS. 2-5, machine 10 of the present invention can provide sequential injection of articles 20a, 20b, for example, bumpers.

The machine 10 of the present invention may include a robotic article loader (not shown), wherein pre-forms, liners, blanks or the like 38 are loaded onto the die sets 26a, 26b of each of movable platens 14a, 14b, respectively, of turret 12. Accordingly, prior to being rotated into alignment, both vertically and horizontally, and longitudinally moved into engagement with stationary die 28 of platen 16, one of sets dies 26a, 26b are loaded with the blank 38. Preferably, liners 38 are held on the dies 26a, 26b of movable platens 14a, 14b, respectively, by a vacuum source (shown schematically) applied through the platens 14a, 14b. Subsequently, turret 12 is rotated so that the die 26a with the blank 38 thereon is in alignment with die 28. Turret 12 is then preferably moved to the closed position such that movable platen 14a and associated die 26a and stationary die 28 and platen 16 are engaged. In this manner, resin may be injected by injection unit over liner 38 for producing a molded article, for example, a two-layered bumper of the color of liner 38. Simultaneously, previously formed part 20b is removed from the exposed die 26b on platen 14b. Thereafter, liner 38 is positioned on the empty and exposed die 26b for subsequent molding operations.

Machine 10 may likewise include a finished article removal mechanism (not shown), which functions to remove finished molded articles 20a, 20b from the dies 26a, 26b of movable platens 14a, 14b, respectively. The removal mechanism is positioned at an article removal area which is substantially unobstructed by a molding area defined between the movable platens 14a, 14b of turret 12 and platen 16 unlike machines using turret blocks which are positioned between two mold halves. Accordingly, article removal area is located outside of the article molding area allowing for clear unobstructed access to finished molded articles for removal. This feature is particularly applicable to the removal of large molded articles or hard to handle molded articles, such as furniture- and complex automotive parts. As a result, substantial space saving is achieved, wherein extra space does not have to be provided upon separation of the platens to accommodate the removal device. In a preferred embodiment, article removal mechanism is in the form of a robotic device (not shown) automatically movable into and out of engagement with finished molded articles in area. Alternatively, another advantage is that unobstructed access to finished molded parts is also provided for manual part removal and/or manual loading of blanks 38.

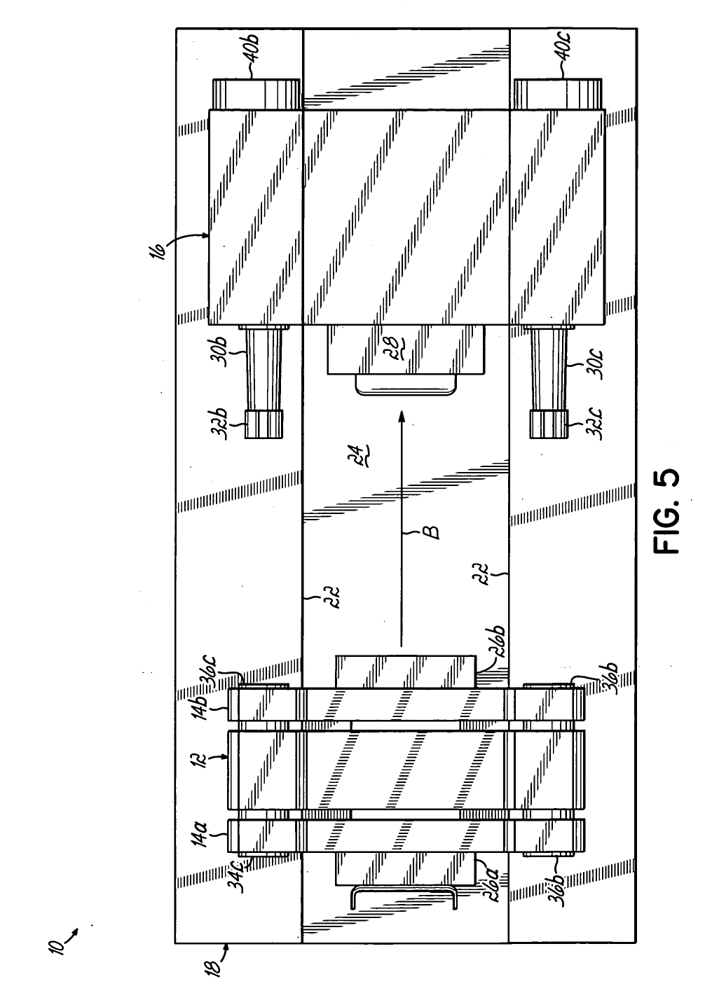

Referring to FIGS. 2-5, after a completed molding operation, turret 12 is then retracted from the stationary platen 16 (FIG. 3) and rotated 180° (FIG. 4) to present a fresh set of dies 26b into alignment and engagement with die 28. Since the molded article 20a shrinks onto the cores it will continue cooling as turret 12 rotates so that the machine 10 can be opened much sooner than with conventional molding cycles. For example, as shown in FIG. 5, while molded article 20a is positioned on the platen 14a, platen 14b is presented for engagement with the platen 16 for molding of article 20b while molded article 20a on movable platen 14a is subject to at least one post molding operation and in many times a plurality of post molding operations including removal from the platen 14a.

In addition, pre-molding operations, such as blank 38 insertion, for preforming multi-layered articles can be accomplished prior to rotation of movable platen 14a or 14b, or any other mold half, back into alignment and engagement with stationary platen 16. Accordingly, post molding or pre-molding operations such as cooling and labeling and finished molded article removal, as shown in FIG. 2, and blank 38 or insert loading as shown in FIG. 2, and discussed above, can be carried out simultaneously to significantly reduce cycle time.

FIGS. 3-4 show rotation of turret 12 in the direction of arrows A. The turret 12 may rotate in the opposite direction, selectively or alternately rotate in one direction and then the opposite or another mode of operation as desired.

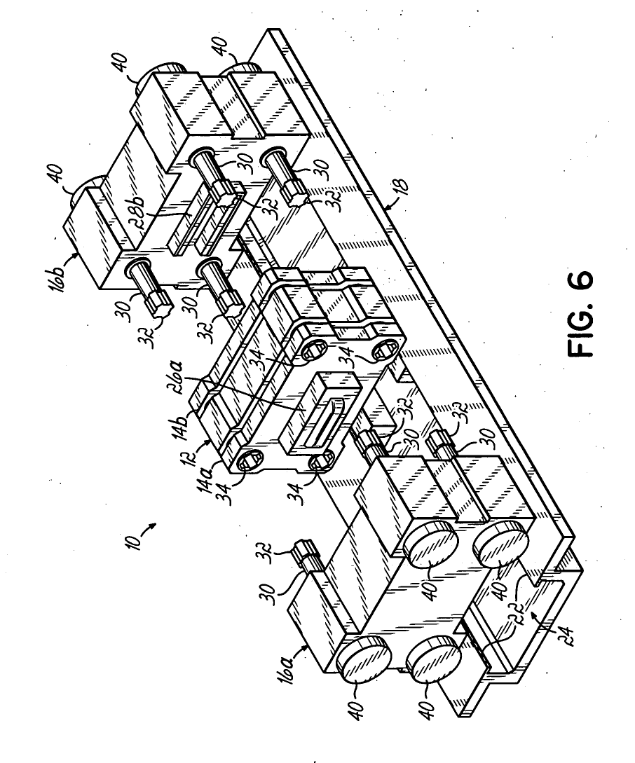

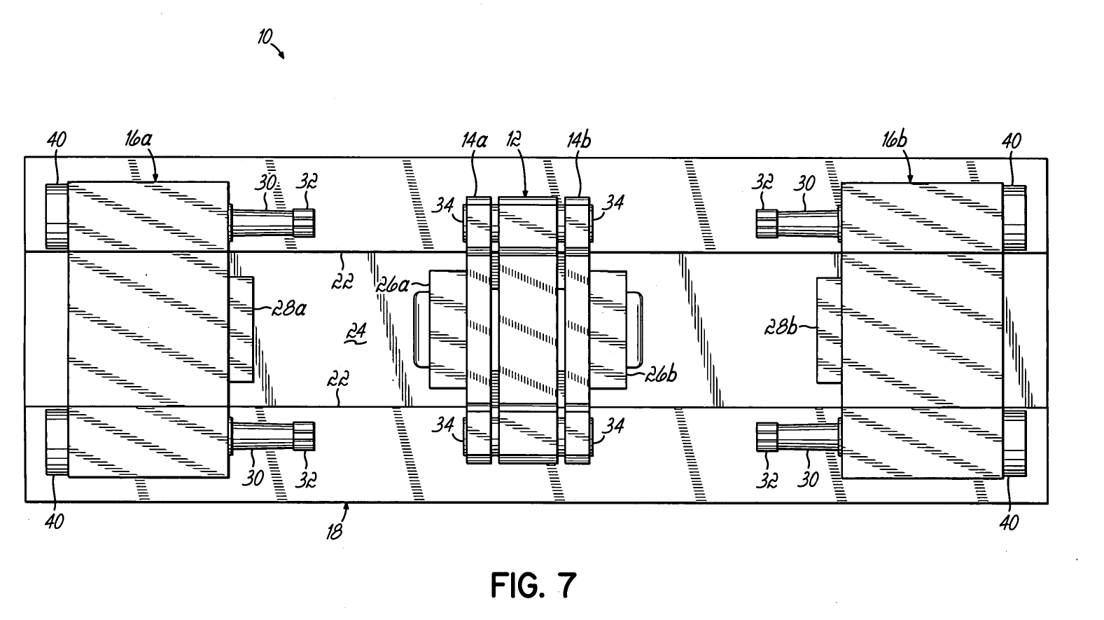

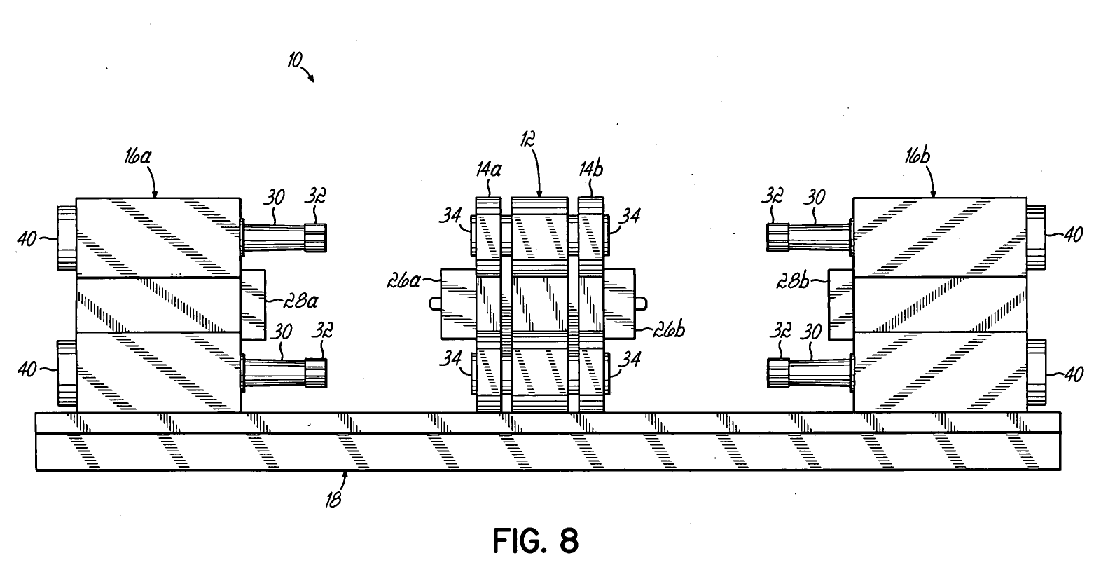

Referring now to FIGS. 6-8, an alternative embodiment of an injection molding machine 10 of the present invention is shown. Elements of this embodiment which are similar to those of prior embodiments disclosed herein are indicated by similar reference numerals. Injection molding machine 10 generally includes a rotatable turret 12 with a plurality of movable mold halves or platens 14a, 14b, and a pair of spaced, opposed stationary mold halves or platens 16a, 16b all positioned on base 18. The machine 10 includes one or more injection units (not shown) for introducing injection material to the stationary platens 16a, 16b utilized in the production of parts 20a, 20b, or the like.

While the turret 12 is shown throughout this description as rotatable on a vertical axis V, and this is the preferred embodiment, it is feasible that a similar design of a movable turret 12 providing the advantages of this invention may be provided which is rotatable on a horizontal or other axis. Accordingly, this invention is not considered limited to the vertical axis feature.

As shown in FIGS. 6-8, turret 12 is preferably longitudinally movable on base 18. Turret 12 is rotatable preferably by a motor (not shown) mounted therein and more preferably an electric servo drive motor. Preferably, the electric servo drive motor is connected via a belt drive about vertical axis V for rotating turret 12. The electric servo drive motor is preferably mounted on the turret 12 proximate the base 18.

Turret 12 includes a plurality of movable platens 14a, 14b, i.e. movable mold halves, each of which includes a set of dies 26a, 26b, respectively, each set adapted for engagement with a die 28a, 28b located in one of the stationary platens 16a, 16b. Preferably, two movable mold halves or platens are provided on turret 12, although any number supportable by the size of the turret 12 can be used. Sets of dies 26a, 26b are adapted to be rotated into horizontal and vertical alignment with dies 28a, 28b.

Tie bars 30 extend from each of the stationary platens 16a, 16b and are selectively connected at distal ends thereof to turret 12 when the corresponding die haves are mated together during molding. Locking bushings 32 are on the distal ends of the tie-bars 30 for locking engagement in sets of locking collars 34 on platens 14a, 14b of the turret 12. The tie-bar mechanism is preferably hydraulic and includes clamping cylinders 40 on the stationary platens 16.

As discussed briefly above, injection molding machine may include a plurality of platens 14a, 14b on the turret 12, although more or less platens may be used, positioned adjacent the periphery of turret 12, which platens are used for the performance of pre-molding or post-molding operations simultaneously with an on-going molding operation. Machine 10 of the present invention can provide sequential injection of articles 20a, 20b, for example, bumpers.

Machine 10 of FIGS. 6-8 provides for significantly increased production capacity and efficiency without commensurate cost and dedicated floor space. Specifically, the movable turret 12 may be operated sequentially between the stationary platens 16a, 16b for repeated and efficient molding operations. Pre and post-molding operations can be performed on platen 14a or 14b while the platen 14b or 14a is being utilized in a molding operation with the mated platen 16b or 16a. As such, cycle time for the molding process is significantly and drastically reduced, thereby increasing efficiency and output for the machine 10. With the machine configuration of FIGS. 66-68, the turret 12 can be utilized effectively as a rotating and translating unit such that various combinations of die halves are employed (i.e., 16a and 14a, then 14a and 16b, or the like). Alternatively, the turret 12 can be utilized as a translating unit such that platen 16a and 14a are repeatedly and sequentially mated together in conjunction with the mating of platens 16b and 14b.

If, in any of the operations discussed above, a molded article formed from more than one material is desired, the plurality of injection units may be used along with the two material hot runner system, as discussed above, for molding articles formed from more than one material.

Any combination of the post-molding and pre-molding operations can be performed while molding is on-going. While it is shown and preferred that the dies be located with the turret 12, it may also be possible to switch the positioning of the dies and cavities among the turret and stationary platen if a movable injection unit is used. Resin, therefore, would be supplied to the mold cavities with other services.

In accordance with the injection molding machines disclosed in detail above, molding cycle time is significantly reduced by comparison to conventional injection molding machines, described above. That is, molded articles may be cooled and removed on the mold cores while other articles are being molded instead of immediately removed after a hold time via ejector. As a result, the mold halves may be separated prior to the completion of cooling since the molded articles, remain on the dies and do not warp or deform since they do not immediately require the integral strength to survive an ejection/stripping action. Accordingly, hold time is substantially eliminated with regard to the molding cycle, reducing the molding cycle by substantially half.

The primary advantage of this invention is that an energy and space efficient multi-platen injection molding machine having a reduced cycle time is provided which includes a longitudinally movable and rotatable turret. Another advantage of this invention is that a multi-platen injection molding machine is provided including a longitudinally movable and rotatable turret, wherein combinations of pre-mold and post mold operations may be efficiently achieved on one machine using different stations of the turret, thereby reducing cycle time. Still another advantage of this invention is that a multi-platen injection molding machine is provided having a longitudinally movable and rotatable turret, wherein operations such as blank loading, temperature conditioning, and direct unloading of molded articles can be achieved in a continuous and efficient manner using one machine having a plurality of stations, thereby reducing cycle time, floor space consumption, and energy consumption.

From the above disclosure of the general principles of the present invention and the preceding detailed description of at least one preferred embodiment, those skilled in the art will readily comprehend the various modifications to which this invention is susceptible. For example, while this invention has been described with reference to an injection molding machine, it is readily applicable to other types of molding and casting operations. Therefore, we desire to be limited only by the scope of the following claims and equivalents thereof.

We claim:

1. A process for injection molding comprising the steps of:
positioning a first blank on a first movable die on a turret of an injection molding machine, the injection molding machine having a first stationary platen and the turret movable relative to the stationary platen, the turret carrying the first and a second movable platen having first and second movable dies, respectively, the first and second movable dies each being capable of mating with a first stationary die on the first stationary platen;
translating the first movable platen toward one of the stationary platens in a first direction;
mating one of the stationary dies with the first movable die;
injecting molding material into the one of the stationary dies and the first movable die to mold a first part;
positioning a second blank on the second movable die on the turret generally concurrently with the molding of the first part;
translating the first movable platen away from the one of the stationary platens in a second direction and toward the other one of the stationary platens;
mating the other one of the stationary dies with one of the movable dies on the turret;
injecting molding material into the other one of the stationary dies and the one of the movable dies on the turret to mold a second part; and
removing the first part from the first movable platen on the turret.

2. The process of claim 1 further comprising:
rotating the turret about an axis generally perpendicular to the first and second directions until the second movable platen is aligned with the one stationary platen after the first part is molded.

3. The process of claim 2 wherein the rotating of the turret is through an arc of about 180°.

4. The process of claim 1 further comprising:
locking each of the stationary dies and one of the movable dies on the turret with tie bars projecting from the stationary platen and selectively engaging the first movable platen.

5. The process of claim 2 further comprising:
rotating the turret about the axis in an opposite direction until the first movable platen is aligned with the other of stationary platens.

6. The process of claim 1 wherein the first and second directions are 180° opposed from each other.

7. A process for injection molding comprising the steps of:
positioning a first blank on a first movable die on a turret of an injection molding machine, the injection molding machine having a first stationary platen and the turret movable relative to the stationary platen, the turret carrying the first and a second movable platen having first and second movable dies, respectively, the first and second movable dies each being capable of mating with a first stationary die on the first stationary platen;
translating the first movable platen toward one of the stationary platens in a first direction;
mating one of the stationary dies with the first movable die;
injecting molding material into the one of the stationary dies and the first movable die to mold a first part;
positioning a second blank on the second movable die on the turret generally concurrently with the molding of the first part;
rotating the turret through an arc of about 180° about an axis generally perpendicular to the first and second directions until the second movable platen is aligned with the one stationary platen after the first part is molded;
translating the first movable platen away from the one of the stationary platens in a second direction opposite from the first direction and toward the other one of the stationary platens;
rotating the turret about the axis in an opposite direction until the first movable platen is aligned with the other of stationary platens;
mating the other one of the stationary dies with one of the movable dies on the turret;
injecting molding material into the other one of the stationary dies and the one of the movable dies on the turret to mold a second part;
locking each of the stationary dies and one of the movable dies on the turret with tie bars projecting from the stationary platen and selectively engaging the first movable platen; and
removing the first part from the first movable platen on the turret.

8. An injection molding machine comprising:
a first and a second stationary platen each mounted on a base;
a first and a second stationary die mounted on the first and second stationary platens, respectively;
a turret movably mounted on the base;
a first and a second movable platen each mounted on the turret;
a first and a second movable die mounted on the first and second movable platens, respectively, each of the first and second movable dies being adapted to mate with at least one of the stationary dies;
at least one injection unit delivering molding material to the stationary platens; and
means for moving the turret relative the stationary platens;
wherein the turret is movable in first and second opposite directions toward and away from, respectively, the stationary platens, the turret also being rotatable about an axis generally perpendicular to the first and second directions for selective alignment of the first and second movable dies with the stationary dies.

9. The machine of claim 8 further comprising:
at least one tie bar projecting from each of the stationary platens and adapted to selectively engage the first and second movable platens for selective locking engagement therewith during molding operations.
